(19) United States
(12) Patent Application Publication
(10) Pub. No.: US 2006/0149930 A1
(43) Pub. Date: Jul. 6, 2006

(54) Systems and methods for improving performance of a forwarding mechanism in a pipelined processor

(76) Inventors: Hiroaki Murakami, Austin, TX (US); Osamu Takahashi, Round Rock, TX (US)

Correspondence Address: LAW OFFICES OF MARK L. BERRIER, 3811 BEE CAVES ROAD, SUITE 204, AUSTIN, TX, 78746, US

(21) Appl. No.: 11/007,066

(22) Filed: Dec. 8, 2004

(51) Int. Cl. G06F 9/30

(52) U.S. Cl. 712/218

(57) ABSTRACT

Systems and methods for forwarding instruction results from various pipeline stages to the initial stages of the pipelines, where the results can be used in the execution of subsequent instructions. In one embodiment, a forwarding mechanism is designed so that sets of one or more dynamic data selection circuits are placed in an alternating linear series with corresponding data registers. Each data register may be coupled to several dynamic data selection circuits, each of which corresponds to a different port or destination register. The dynamic data selection circuits coupled to a single data register are successively positioned in a direction that is perpendicular to the direction of the alternating linear array. Each dynamic data selection circuit may consist of a 2-input NOR gate coupled to drive a discharge transistor. The dynamic data selection circuits themselves may be aligned with the alternating series of latches and data selection circuits.

### BACKGROUND

1. Field of the Invention

The invention relates generally to computer systems, and more particularly to systems and methods for improving the performance of a forwarding mechanism in a pipelined processor.

2. Related Art

Computer systems operate by executing computer programs, or applications. Computer programs consist of a set of individual instructions that are executed by a data processor, causing the data processor to perform corresponding operations. These operations may include such things as loading data from memory into internal registers, performing mathematical or logical operations on this data, storing data to memory, and so on.

In early computer systems, program instructions were executed one at a time. In other words, execution of each instruction was completed before execution of the next instruction was begun. Some instructions might be executed in a single cycle, while others might require several cycles to complete.

The execution of a particular instruction typically has several stages. For example, it may first be necessary to retrieve (fetch) a program instruction, then decode the instruction and retrieve any data upon which the instruction will operate, then perform an operation indicated by the instruction and perform an address calculation, then perform a memory access. A processor may have components that are configured to perform the specific functions associated with each of these stages. If only one instruction is performed at a time, a particular component or set of components performs the functions of the corresponding stage and is idle for the remainder of the time the instruction is being executed.

It is possible to improve the throughput of a processor by making use of the functional units that are idle when only a single instruction is performed at one time. This is accomplished by “pipelining” the processor. In other words, the processor is designed to segregate the different stages of execution so that, after a particular function is performed for a first instruction, that instruction is [moved] to the next stage and the function is performed for a second instruction. For example, in a first cycle, an instruction fetch might be performed to retrieve a first instruction, then, in a second cycle, the instruction fetch would be performed for a second instruction and an instruction decode and data fetch would be performed for the first instruction, and so on.

If the program instructions are independent of each other, this process is repeated for each succeeding instruction. If there are n stages in the pipeline, the throughput of the processor is n times higher than if a single instruction must be executed to completion before execution of another instruction begins. As a practical matter, however, the increase in the throughput of the processor may not be as high because it is more typical for the instructions to have dependencies upon each other than to be completely independent. As a result, it may be necessary to execute one instruction to completion in order to have a result that is necessary to begin a subsequent instruction. For instance, in order to add three numbers, it may be necessary to add two of the numbers, generate a resulting intermediate value, and then add the third number to the intermediate value.

The impact of instruction dependencies on the throughput of the processor may be minimized in various ways. For example, the instructions may be rearranged so that dependent instructions are spaced apart so that the subsequent, dependent instruction does not prevent execution of other instructions while it is waiting for the result of a preceding instruction. Another way to minimize the impact of instruction dependencies is to provide a mechanism for obtaining the needed result of the preceding instruction before execution of the instruction is complete, and forwarding this result to the pipeline stage where it is needed for execution of the subsequent instruction.

Some modern processors include multiple pipelines, each of which may have several different functional units. The functional units may complete the corresponding operations in different amounts of time (numbers of processing cycles) and may therefore produce results that are available at different times after execution of a corresponding instruction begins. It may therefore be necessary to obtain the instruction results from many different pipeline stages. Further, it may be necessary to provide the instruction results from these different pipe line stages to the initial stages of each of the different pipelines. The result forwarding mechanism in the processor may therefore be very complex.

Conventional processors typically use static circuits to implement the result forwarding mechanism described above. Because there is a demand for increased processing capacity, there is a need to increase the scale (hence the complexity) and performance of processors. This results in a corresponding need for forwarding mechanisms that are scalable and that have increased performance. This need is not easily met by conventional static circuit designs. There is therefore a need for improved forwarding mechanism designs that use dynamic circuits. These dynamic circuits need to be designed to maximize the performance of the forwarding mechanism.

### SUMMARY OF THE INVENTION

One or more of the problems outlined above may be solved by the various embodiments of the invention. Broadly speaking, the invention includes systems and methods for systems and methods for forwarding instruction results from various pipeline stages to the initial stages of the pipelines, where the results can be used in the execution of subsequent instructions. In one embodiment, a forwarding mechanism is designed so that a set of dynamic data selection circuits are placed in an alternating series with a corresponding set of data latches or registers. Each data latch may be coupled to several dynamic data selection circuits, where each dynamic data selection circuit corresponds to a different port or destination register. Each dynamic data selection circuit may consist of a 2-input NOR gate coupled to drive a discharge transistor. The dynamic data selection circuits themselves may be aligned with the alternating series of latches and data selection circuits.

One embodiment comprises a forwarding mechanism for a pipelined processor, including a first unit that has a data register and a set of dynamic data selection circuits. Each of the dynamic data selection circuits is located adjacent to the data register. The set of dynamic data selection circuits is positioned in a first direction with respect to the data register. The dynamic data selection circuits within the set are positioned successively along a second direction which is perpendicular to the first direction. The first unit and one or more additional units which are identical to the first unit may be positioned successively adjacent to each other along the first direction to form an alternating linear series of data registers and sets of data selection circuits. In one embodiment, each of the dynamic data selection circuits includes a set of components that are aligned in the first direction. One or more output data lines are coupled to the dynamic data selection circuits in order to output data values selected by the circuits. The output data lines may be positioned between shield wires (e.g., ground wires) of the dynamic data selection circuits.

Numerous additional embodiments are also possible.

### BRIEF DESCRIPTION OF THE DRAWINGS

Other objects and advantages of the invention may become apparent upon reading the following detailed description and upon reference to the accompanying drawings.

FIG. 1 is a functional block diagram illustrating the structure of a pipelined processor employing a result forwarding mechanism.

FIG. 2 is a diagram illustrating the high-level structure of the forwarding mechanism of the processor of FIG. 1.

FIG. 3 is a diagram illustrating the structure of a 10-way multiplexer that uses static logic circuits in accordance with the prior art.

FIG. 4 is a diagram illustrating the structure of multi-bit tri-state buffer mechanism in accordance with the prior art.

FIG. 5 is a diagram illustrating the gate level structure of a dynamic data selection circuit in accordance with one embodiment.

FIG. 6 is a diagram illustrating the transistor level structure of a dynamic data selection circuit in accordance with one embodiment.

FIG. 7 is a diagram illustrating a set of components including a data register and a corresponding set of dynamic data selection circuits in accordance with one embodiment.

FIG. 8 is a diagram illustrating the connection of a register and data selection circuit, as well as a precharge circuit to an output line in accordance with one embodiment.

FIG. 9 is a diagram illustrating a forwarding mechanism including multiple sets of registers and corresponding data selection circuits in accordance with one embodiment.

FIG. 10 is a diagram illustrating the physical layout of the dynamic circuit of FIG. 6 in accordance with one embodiment.

While the invention is subject to various modifications and alternative forms, specific embodiments thereof are shown by way of example in the drawings and the accompanying detailed description. It should be understood that the drawings and detailed description are not intended to limit the invention to the particular embodiments which are described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

Broadly speaking, the invention includes systems and methods for forwarding instruction results from various pipeline stages to the initial stages of the pipelines, where the results can be used in the execution of subsequent instructions. In one embodiment, a forwarding mechanism is designed so that a set of dynamic data selection circuits are placed in an alternating series with a corresponding set of data latches or registers. Each data register may be coupled to several dynamic data selection circuits, where each dynamic data selection circuit corresponds to a different port or destination register. Each dynamic data selection circuit may consist of a 2-input NOR gate coupled to drive a discharge transistor. The dynamic data selection circuits themselves may be aligned with the alternating series of registers and data selection circuits.

This forwarding mechanism may provide improved performance, not only because the data selection circuits are dynamic rather than static, but also because the configuration of the mechanism meets three design goals. The first of these goals is to shorten the length of dynamic signal lines. The second goal is to position dynamic signal lines between shield wires. The third goal is to minimize the distance between the output of a data register and the input of a corresponding dynamic circuit. The relationship of these design goals to the embodiments of the invention will be discussed in more detail below.

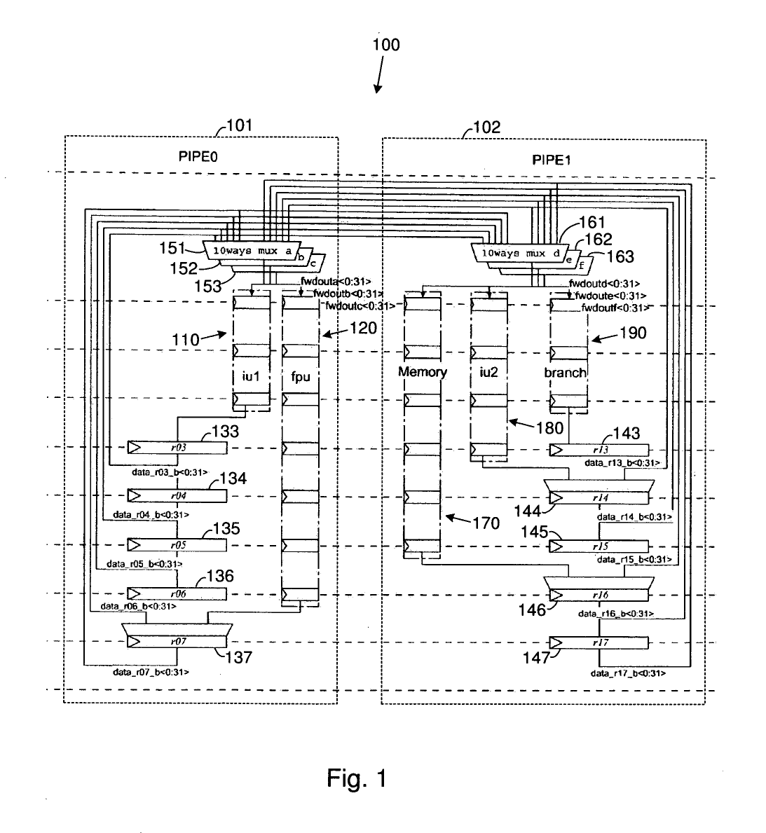

Referring to FIG. 1, a functional block diagram illustrating the structure of a pipelined processor employing a result forwarding mechanism is shown. Processor 100 includes two pipelines, 101 and 102. Each of pipelines 101 and 102 has multiple functional units (110, 120, 170, 180 and 190,) as well as multiple registers or latches (133-137 and 143-147) for storing results generated by the functional units. The results stored in registers 133-137 and 143-147 are provided to multiplexers 151-153 and 161-163. Multiplexers 151-153 and 161-163 can then be controlled to provide the contents of any of registers 133-137 and 143-147 to any of the functional units (or registers associated with these functional units) for use in executing subsequent instructions.

It should be noted that the terms “register” and “latch” are both used herein to refer to means for storing data. These terms should both be construed in this manner, and the use of either term is not intended to imply any limitations that would exclude the other.

It should be noted that FIG. 1 shows only a functional portion of each pipeline. This portion may be preceded by other portions such as an instruction fetch portion and an instruction decode/register fetch portion. The functional portion of the pipeline may also be followed by such portions as a memory access portion and a write back portion. These other portions of the pipeline are not necessary to an understanding of the invention, and consequently are not shown in figure for purposes of clarity.

In processor 100, an instruction enters one of pipelines 101 and 102, depending upon the type of the instruction. It can be seen that each of the pipelines has different types of functional units that are configured to execute corresponding types of instructions. For instance, a floating-point instruction would enter pipeline 101 because this pipeline has a floating-point functional unit, 120.

In the embodiment of FIG. 1, each functional unit requires multiple processor cycles to complete the corresponding functional processing of the instructions. Each functional unit may therefore be considered to have multiple pipeline stages. (In early pipelined processors, the functional processing performed by these functional units was sometimes handled in a single pipeline stage.) Thus, if an integer instruction is received by pipeline 101, which requires two cycles two process the instruction, a first stage of processing is performed on the instruction during a first cycle, and a second stage of processing is performed on the instruction during a second cycle. After the instruction has been executed to completion (e.g., after both stages of functional unit 110 have completed processing the instruction,) and a result has been generated, the result is stored in successive ones of the registers (133-137 and 143-147.)

In this exemplary processor, it is assumed that each pipeline can accept and begin processing a new instruction in each successive processing cycle. After a first instruction is processed by a first stage of the pipeline, that instruction advances to the second stage of the pipeline. After the first instruction has advanced to the second stage of the pipeline, the first stage of the pipeline is available to process a subsequent instruction. When the first instruction advances to the third stage (assuming that the functional unit has three or more stages,) the second instruction advances to the second pipeline stage, and a third instruction enters the first stage of the pipeline.

It should be noted that the stages of the pipelines are effectively delineated by registers between the stages. At the beginning of a processing cycle, a data value is stored in the register that precedes the pipeline stage (the “upstream” register.) This upstream register maintains this data value so that the data value can propagate through the logic of the pipeline stage. The pipeline stage logic is designed so that the data value will propagate entirely through the logic by the end of the processing cycle. The resulting data value at the output of the pipeline stage logic is provided to the register that follows the pipeline stage (the “downstream” register,) and is stored in this downstream register at the beginning of the next processing cycle. Thus, the instructions (or more accurately, the intermediate values corresponding to the execution of the instructions) advance through the pipeline, one pipeline stage per processing cycle.

Because the instructions “step” through the processor pipelines in this manner, it is convenient to represent the stages of the pipelines (and corresponding registers) as being aligned horizontally. The registers at the beginning (and end) of each stage in the different functional units are therefore aligned in FIG. 1 as indicated by the horizontal dashed lines.

As noted above, each of the different functional units within the processor may require different amounts of time (numbers of cycles) to completely process and instruction of the corresponding type. For example, functional unit 110 is an integer unit that requires only two cycles to process a corresponding integer instruction, while functional unit 120 is a floating-point unit that requires six cycles to completely process a floating-point instruction.

When a result is generated by the functional units, it is stored in a register. Because the different functional units require different numbers of cycles to process the respective instructions, additional registers are provided to store the results produced by the faster functional units during the time that slower functional units would still be processing an instruction. Thus, an integer instruction to be executed by integer unit 110 is processed by a first stage of the unit in a first cycle and by a second stage of the unit in a second cycle, then is shifted to registers 133-137 in five successive cycles. A floating point instruction, on the other hand, is processed through the six stages of functional unit 120 in six successive cycles, then is stored in register 137 on the next cycle. In the embodiment of FIG. 1, multiplexers are included in the chain of registers to allow the registers to receive result values are either from a preceding register or from a functional unit.

It should be noted that, while the foregoing description pertain specifically to pipeline 101, pipeline 102 operates in the same manner, and the description of the various components of pipeline 101 are also applicable to pipeline 102.

As pointed out above, there are sometimes dependencies between the instructions. In other words, it is sometimes the case that the result of one instruction is needed in order to execute a subsequent instruction. If the subsequent instruction closely follows the first instruction, execution of the subsequent instruction may be delayed while the first instruction is being executed. It is therefore desirable to be able to provide the result of the first instruction as quickly as possible after the result is generated.

Because the data values stored in registers 133-137 and 143-147 are completed results generated by the respective functional units, these values are available for use in processing subsequent instructions that require these results as inputs. The purpose of a forwarding mechanism is to forward these results from the registers that store the results (133-137 and 143-147) to the initial stages of the pipelines.

In the embodiment of FIG. 1, the forwarding mechanism consists primarily of the registers (133-137 and 143-147) that store the results produced by the functional units and the multiplexers (151-153 and 161-163) that allow particular ones of the registers to be selected so that the corresponding results can be used by subsequent instructions.

As described above, each one of pipelines 101 and 102 receives an instruction which is processed about one of the associated functional units. In this embodiment, three instruction registers are provided in each pipeline to store the data that is used in the execution of each instruction. Prior to processing the instruction in one of the functional units, one or more of these instruction registers may be loaded with necessary data. For instance, if the instruction adds two values, it is necessary to load these values into two of the instruction registers. If the values were previously computed and/or stored, they may be fetched from the memory location in which they were stored. If the values were generated by a previous instruction and are currently in one of result registers 133-137 or 143-147, they may be loaded from these result registers using the forwarding mechanism. After the appropriate functional unit begins processing this instruction, a different set of data values can be loaded into the instruction registers for use in the execution of the next instruction.

It should be noted that, because data is forwarded from the result registers to the instruction registers, the result registers may be referred to herein as source registers, and the instruction registers may be referred to as destination registers.

It should be noted that, in this embodiment, pipelines 101 and 102 are operating in parallel. Each of the pipelines may therefore require data to be loaded into the instruction registers at the same time. Similarly, each of the pipelines may generate instruction results at the same time. Because an instruction that will be processed in one of the pipelines may require data that is generated by an instruction in the other of the pipelines, the forwarding mechanism in this embodiment is configured to make the results stored in all of the result registers available to all of the instruction registers.

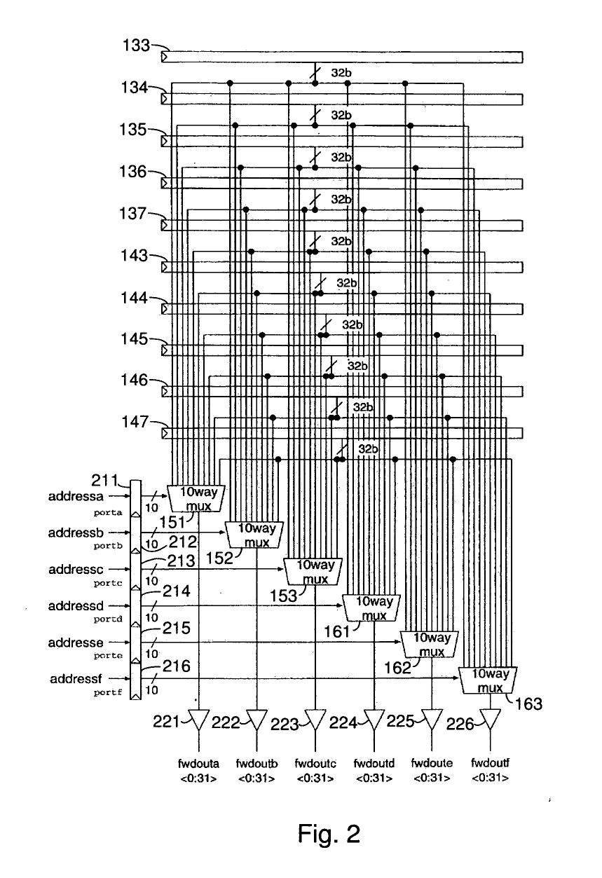

Referring to FIG. 2, a diagram illustrating the high-level structure of the forwarding mechanism of the processor of FIG. 1 is shown, apart from the processor. In this diagram, the ten result registers (133-137 and 143-147) are each connected to the six multiplexers (151-153 and 161-163). Each of multiplexers 151-153 and 161-163 receives a select signal from a corresponding one of address registers 211-216. Based upon the respective select signals, each of multiplexers 151-153 and 161-163 selects one of result registers 133-137 and 143-147 and passes the result stored in the register through the multiplexer to a buffer (221-226) that drives the value to the associated instruction register.

It should be noted that FIG. 2 does not explicitly depict the set of instruction registers to which the result values are forwarded. It should be noted that, while the results are forwarded to registers in this environment, alternative embodiments may not require that the values be stored in registers. The values may, for example, be provided directly to the functional logic of the pipeline stage that would otherwise receive the values from the instruction registers. References to instruction registers should therefore be broadly construed to include both actual registers and logic to which the result values are provided.

As depicted in FIG. 2, each of the result registers in this embodiment stores a 32-bit result value. Each result register is coupled to the six multiplexers via corresponding signal lines to provide the 32-bit value to the multiplexers. Thus, each multiplexer receives ten different 32-bit wide inputs. Each multiplexer has a single 32-bit wide output. Each multiplexer receives a single 10-bit wide control input from the corresponding address register that controls the selection of one of the 32-bit inputs to be provided as the single 32-bit output. The 10-bit control signal in this embodiment is a “one-hot” signal with a bit corresponding to each of the different inputs. The signal is referred to as a one-hot signal because one of the 10 bits is a 1, and all of the other bits are 0. The input selected to be output by the multiplexer is the one corresponding to the bit that is set to 1.

The forwarding structure of FIG. 2 is relatively complex. The complexity in becomes more apparent when one considers the fact that each of the many signal lines between the result registers and the multiplexers is a simplified representation of the 32 different signal lines that are required to carry each 32-bit wide result value. The same is true of the multiplexer output lines and the 10-bit wide control signal lines between the address registers and the multiplexers. As the numbers of pipelines and/or functional units in processors increase, the number of signal lines and the complexity of the forwarding structure increase even more dramatically. This increased complexity can outdistance the potential performance of static logic circuits, making it necessary to use dynamic circuits.

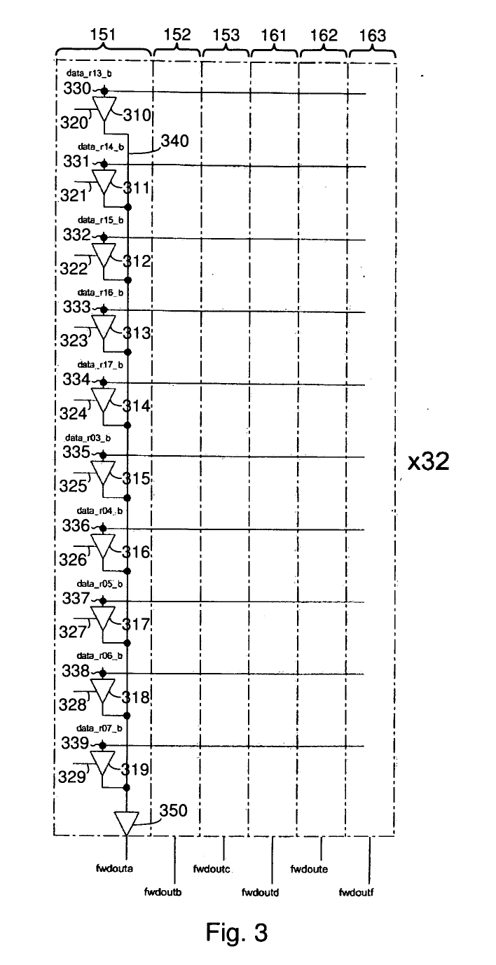

Referring to FIG. 3, a diagram illustrating the structure of a 10-way multiplexer that uses static logic circuits in accordance with the prior art is shown. This figure depicts each of multiplexers 151-153 and 161-163 as a vertical block. The multiplexers are placed side-by-side horizontally across the page. The detail of multiplexers 152-153 and 161-163 is not shown, but the structure of each of these multiplexers is the same as the structure of multiplexer 151. The differences between the multiplexers are the different control inputs.

As shown in FIG. 3, multiplexer 151 consists of a set of 10 tri-state buffers 310-319. Tri-state buffers 310-319 each has a corresponding control input (320-329) and data input (330-339.) The outputs of tri-state buffers 310-319 are all coupled to a common output signal line 340. Each of control inputs 320-329 is a single-bit signal that turns the corresponding tri-state buffer on or off. The combined signals on control input lines 320-329 comprised the output of address register 211 shown in FIG. 3. When one of the control inputs is 1, the data input to the corresponding tri-state buffer is passed through to the output of the tri-state buffer. When the control input to the tri-state buffer is 0, the output of the tri-state buffer appears as a high impedance. In other words, from output signal line 340, the tri-state buffer appears to be disconnected. Since only one of the signals on control input lines 320-329 is 1, and all of the others are 0, output line 340 is effectively connected to the data input of the selected tri-state buffer (the one whose control input is 1) and disconnected from the remainder of the tri-state buffers' data inputs.

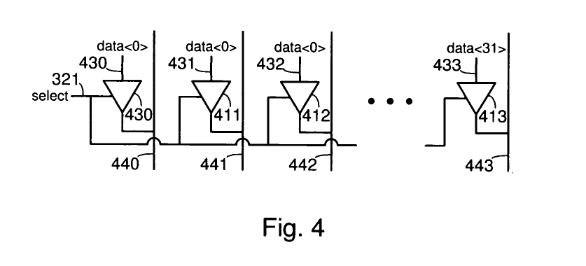

It should be noted that tri-state buffers 310-319 which are depicted in FIG. 3 are multi-bit devices. In other words, tri-state buffers 310-319 selectively pass through 32 bits of data rather than only a single bit. Each of multi-bit tri-state buffers 310-319 consists of a series of single-bit tri-state buffers. This is shown in FIG. 4, which is a diagram illustrating the structure of multi-bit tri-state buffer mechanism 311. Multi-bit tri-state buffer 311 includes 32 one-bit tri-state buffers 410-413 (only four of the 32 one-bit tri-state buffers are depicted in the figure.) Each of the one-bit tri-state buffers receives a single bit of data on a corresponding data line 430-433. The same one-bit control signal is provided to all 32 of one-bit tri-state buffers 410-413 via line 321. If the control signal on line 321 is a 1, all of one-bit tri-state buffers 410-413 are turned on, and the corresponding bits received on data lines 430-433 are passed through to the respective ones of output lines 440-443. If the control signal on line 321 is a 0, all of one-bit tri-state buffers 410-413 are turned off and are effectively disconnected from output lines 440-443. Together, the 32 output lines (440-443) comprise 32-bit output line 340 depicted in FIG. 3.

As pointed out above, the multiplexers illustrated in FIGS. 3 and 4 comprise static logic circuits. In order to provide improved performance, particularly in increasingly complex and large-scale systems, the static data selection circuits of FIGS. 3 and 4 are replaced with dynamic circuits. In one embodiment, this involves replacing each of the one-bit tri-state buffers with a circuit that includes a NOR gate and a discharge transistor.

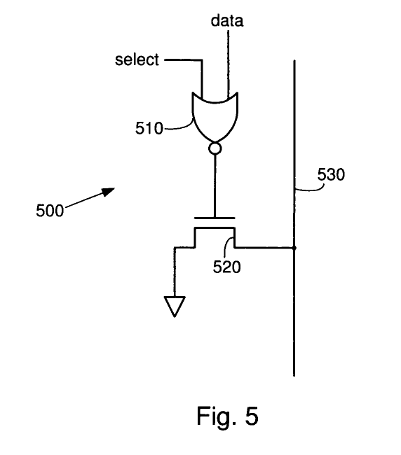

Referring to FIG. 5, a diagram illustrating a dynamic data selection circuit in accordance with one embodiment is shown. Data selection circuit 500 is configured to receive a one-bit data signal and a one-bit select signal (control signal,) and to provide a one-bit output signal on a common output line. In this embodiment, the data selection circuit includes a NOR gate 510 and a discharge transistor 520. NOR gate 510 has two inputs. One of the inputs is coupled to receive a data bit, while the other input is coupled to receive the select signal. The output of NOR gate 510 is coupled to the gate of discharge transistor 520. Discharge transistor 520 is coupled between common output line 530 and ground.

Dynamic data selection circuit 500 achieves the same result as a single-bit tri-state buffer, but in a slightly different manner. First, it should be noted that the select signal used with dynamic data selection circuit 500 is the inverse of the tri-state buffer select signal. In other words, the tri-state buffer is turned on it (i.e., passes through the data signal) when the select signal is 1, while circuit 500 passes data through to the output line when the select signal is 0. It should also be noted that output signal line 530 is not actually driven by the data line (or by the output of NOR gate 510.) Output signal line 530 is instead pre-charged to Vdd (1) and is pulled to ground when discharge transistor 520 is switched on.

Whenever the select signal is 1, the output of NOR gate 510 is low, and discharge transistor 520 is switched off. Discharge transistor 520 remains switched off, regardless of the value of the data input to NOR gate 510. Output line 530 is thereby effectively decoupled from the data input to NOR gate 510. This is the equivalent in dynamic circuit 500 to the high impedance state of the tri-state buffer in the static circuit. When the select signal is 0, the output of NOR gate 510 is dependent upon the value of the data at the other input of the NOR gate. If the data value is 0, the output of NOR gate 510 is 1, and discharge transistor 520 is switched on, coupling output line 530 to ground. If the data value is 1, the output of NOR gate 510 is 0, and discharge transistor 520 is switched off, decoupling output line 530 from ground. Thus, output line 530 follows the data value input to NOR gate 510.

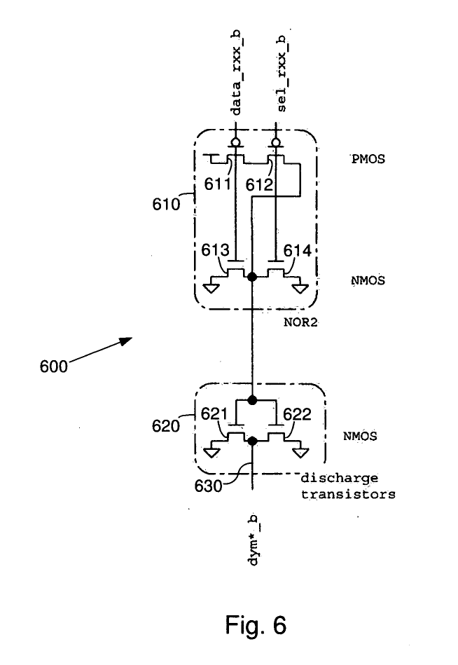

As will be discussed in more detail below, it may be desirable to structure the dynamic data selection circuit in a way that positions dynamic signal lines between shield wires. To this end, the dynamic data selection circuit may be implemented using the design shown in FIG. 6. As depicted in this figure, the dynamic data selection circuit includes a NOR gate 610 and a discharge circuit 620. While NOR gate 610 is exactly equivalent to NOR gate 510, discharge circuit 620 is slightly different from the discharge circuit formed by discharge transistor 520. The difference is that there are two discharge transistors, 621 and 622, instead of a single discharge transistor, 520.

As noted above, NOR gate 610 is equivalent to NOR gate 510. NOR gate 610 is implemented using four transistors, 611-614. These transistors include two PMOS transistors, 611 and 612, and two NMOS transistors, 613 and 614. The source of transistor 611 is coupled to Vdd, and the drain is coupled to the source of transistor 612. The drain of transistor 612 is coupled to an output line 650 of NOR gate 610. The sources of transistors 613 and 614 are also coupled to line 650, while the drains of these transistors are coupled to ground. The gates of transistors 611 and 613 are coupled to receive the select input signal, while the gates of transistors 612 and 614 are coupled to receive the data input signal. NOR gate output line 650 is coupled to the gates of discharge transistors 621 and 622. The sources of transistors 621 and 622 are both coupled to common output line 630, while the drains of these transistors are both coupled to ground.

It should be noted that single-bit dynamic circuit 500 (or 600) can be reproduced and interconnected to form a multiple-bit wide data select circuit equivalent to the multiple-bit wide static circuit illustrated in FIG. 4. Similarly, such a multiple-bit wide dynamic circuit can be reproduced and interconnected in the same manner in which the multiple-bit wide static circuits are interconnected to form a multiplexer as shown in FIG. 3.

The dynamic data selection circuits described above are used in the present embodiments to provide improved performance over conventional static circuits. As mentioned above, the scale, speed and complexity of modern processors are increasing. Likewise, the forwarding mechanisms in these processors have increased scale and complexity, and it is becoming more difficult for conventional static circuits to provide satisfactory performance in these systems. The forwarding mechanisms described herein can provide improved performance, not simply by using dynamic data selection circuits, but also by configuring these circuits and the other components of the forwarding mechanism in ways that meet various design goals.

Various factors can affect the performance of the forwarding mechanism. First, because there is coupling capacitance between dynamic signal lines, the length of these signal lines may affect their performance. Generally speaking, shorter lines will experience less interference arising from coupling capacitance with other lines. Further, it is generally beneficial to place these dynamic lines between shield wires because of the coupling capacitance between dynamic signal lines. Another factor affecting the performance of the forwarding mechanism is the distance between the data registers and the data selection circuits. Because there is load capacitance on the lines from the registers to the data selection circuits, the distance between the registers and the selection circuits should be minimized so that the output of the registers can more quickly stabilize and be used by the data selection circuits.

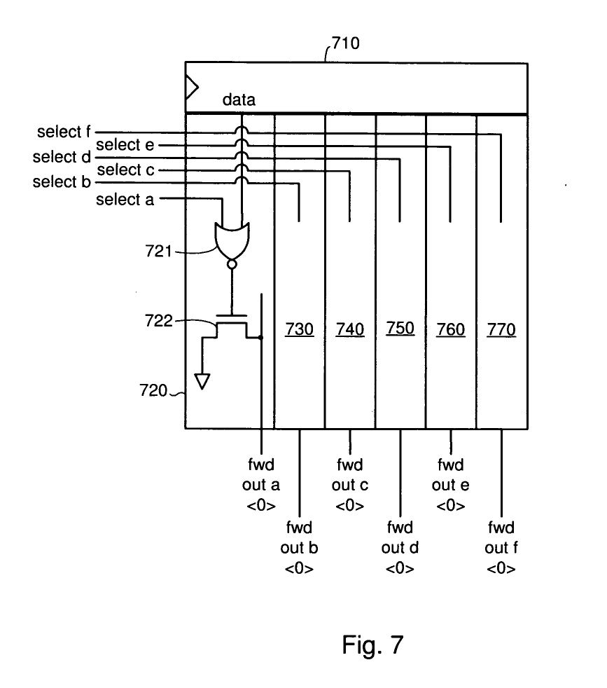

In one embodiment, all three of these design goals are met by placing one or more sets of data registers and adjacent data selection circuits next to each other to form the multiplexers of a processor data forwarding mechanism. Referring to FIG. 7, a diagram illustrating a set of components including a data register and a corresponding set of dynamic data selection circuits is shown.

Each of dynamic data selection circuits 720, 730, 740, 750, 760 and 770 are coupled to register 710. Each of these data selection circuits corresponds to a different one of the instruction registers. In the examples described above, there are six instruction registers and six corresponding multiplexers that select the data needed for each of the instruction registers from one of the ten result registers. The system may therefore be said to have six ports. Each of the six data selection circuits forms a portion (one way) of the corresponding 10-way multiplexer.

It should be noted that the dynamic data selection circuits are placed adjacent to the data register in a first direction. That is, the position of the data selection circuits is a first direction (vertically downward in the figure) with respect to the position of the data register. Further, each of the data selection circuits is positioned sequentially along a second direction (horizontally in the figure) which is perpendicular to the first direction. It should also be noted that each of the data selection circuits has its components (a NOR gate, a discharge circuit and an output line) aligned with the first direction (vertically in the figure.)

In this figure, register 710 stores a single bit of data. Register 710 forms a portion of one of the ten result registers described in the foregoing examples. Thus, there are 31 additional single-bit registers that form the remainder of the result register. Each of these additional single-bit registers has a set of six dynamic data selection circuits as described here in connection with register 710.

The data bit stored in register 710 is provided to data selection circuit 720. As depicted in the figure, data selection circuit 720 consists of a NOR gate 721 and a discharge transistor 722. The inputs to NOR gate 721 include the data bit from register 710 and a select signal. The select signal for data selection circuit 720 is select_a. A different one of select signals select_a-select_f is used for each of data selection circuits 720-770. The select signal determines whether or not the data bit in register 710 will be driven onto a common output line for the data selection circuit. Data selection circuit 720 operates as described above in connection with FIG. 5.

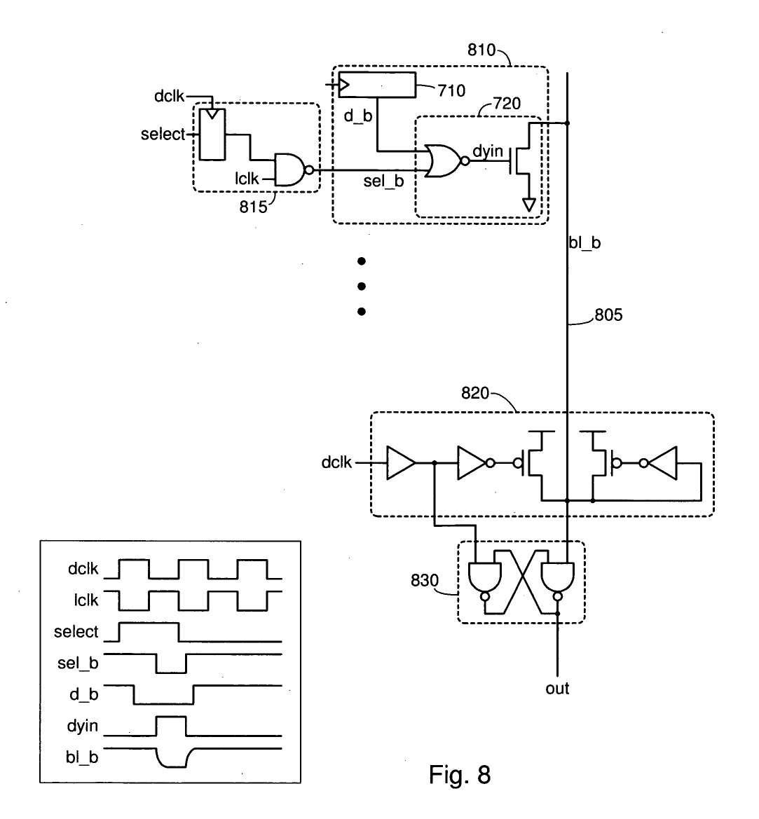

It should be noted that the common output line is common to data selection circuits which are coupled to other single-bit registers, and is not common to data selection circuits 730, 740, 750, 760 and 770. It should also be noted that each common output line includes a precharge circuit that precharges the line to Vdd. The output line can then be pulled down to ground by activation of the discharge circuit of one of the data selection circuits. The precharge circuit is shown in FIG. 8.

Referring to FIG. 8, a diagram illustrating the connection of a register and data selection circuit, as well as a precharge circuit to an output line in accordance with one embodiment is shown. The illustrated circuit corresponds to a single bit of a single port. In this circuit, common output line 805 is coupled to ten data selection circuits and corresponding registers. One set (810) consisting of register 710 and data selection circuit 720 is shown. The select signal for set 810 is provided by timing circuit 815. Other sets are identical to set 810/815, except that each may hold different data and may receive a different select signal. Output line 805 is initially precharged to Vdd by precharge circuit 820. Then, if the register coupled to the selected data selection circuit holds a 0, the discharge transistor of the data selection circuit will be activated and output line 805 will be pulled to ground. If the register holds a 1, the output line will not be discharged, but will remain at Vdd.

This process of alternately precharging output line 805 and (possibly) discharging the line results in a signal that follows the data value in the selected register only half of the time. The other half of the time, the output line will be at Vdd. The illustrated circuit therefore employs two cross-coupled NAND gates to convert the data signal from half of a clock cycle to a full clock cycle. The timing of the signals in this circuit are illustrated in the figure, and will not be discussed in detail here.

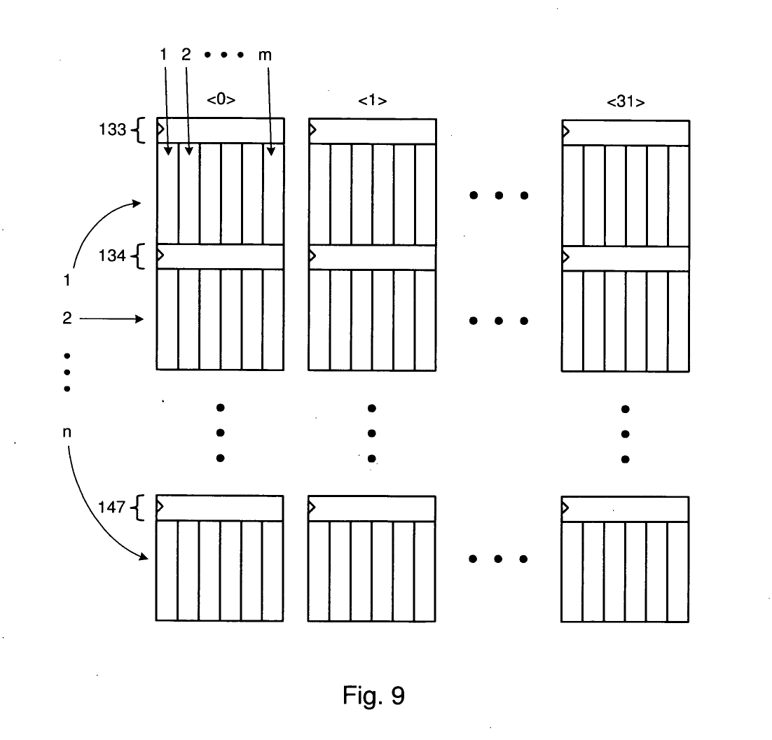

Referring to FIG. 9, a diagram illustrating a forwarding mechanism including multiple sets of registers and corresponding data selection circuits is shown. In connection with the description of FIG. 9, each set of one single-bit register and six corresponding dynamic data selection circuits (as shown in FIG. 7) will be referred to as a “unit.” Each unit in this figure is depicted as a block with a single horizontal bar (the register) and six vertical bars (the data selection circuits.)

FIG. 9 includes 320 units in 10 rows and 32 columns. The units in each row include 32 single-bit registers that make up the corresponding 32-bit result register. For example, the first row may correspond to register 143, the second row may correspond to register 144, and so on. The units in each column include 10 data selection circuits for each of the six multiplexers (corresponding to the six instruction registers.) Each column may therefore be viewed as including six one-bit, 10-way multiplexers. The 32 columns make up six 32-bit, 10-way multiplexers.

As noted above, each unit receives six select signals that control whether the data bit stored in the unit is driven onto the corresponding output line. (Each column has six output lines, with each output line being coupled to the corresponding data selection circuit in each unit.) The same six select signals are provided to each of the units in a row. Thus, if a register in the first row of the first column is selected to drive it data bit onto the output line corresponding to a first port, the registers in the first row of all of the columns will be selected to drive their data bits onto the output lines corresponding to the first port. The entire 32-bit data value stored in the 32-bit register (the 32 combined single-bit registers in the first row) will therefore be output to the first port (and provided to the corresponding instruction register.)

It should be noted that the structure illustrated in FIG. 9 can be generalized to an m-port, n-way multiplexer. As used here, m corresponds to the number of destination registers to which data can be forwarded. There will be a set of m data selection circuits in each unit. In the generalized forwarding mechanism, n corresponds to the number of result registers from which the data can be forwarded. There will be n rows of units in the forwarding mechanism. The structure of the illustrated forwarding mechanism may also be generalized to accommodate different data having different bit-widths. There will be a column of units for each bit of the data width.

This physical arrangement is useful because it meets some of the design goals noted above. For instance, because each dynamic data selection circuit is located adjacent to the register from which it receives data, the signal line which delivers the data from the register to the selection circuit is shortened. The shortened signal line has less coupling capacitance than a longer signal line and therefore experiences less interference from other signal lines. This increases the performance of the forwarding mechanism. Additionally, the shortened signal line has less loading capacitance than a longer signal line. Because there is less loading capacitance, the data value output by the register should stabilize more quickly than if there were more loading capacitance. Since the register's output value can stabilize more quickly, the forwarding mechanism can operate at higher speeds.

This configuration is also advantageous because all of the data selection circuits corresponding to a particular single-bit register, rather than only a single one of the data selection circuits, are placed adjacent to the register. Thus, none of the data selection circuits has a substantially longer data input line than the others.

Another advantage of this configuration is that, because all of the data selection circuits for a particular port are aligned (vertically) in an alternating linear series with the registers. The common output line to which each of these data selection circuits is coupled is therefore shortened. As with the input data lines, these shortened dynamic output lines experience less coupling capacitance and consequently less interference than longer output lines. Further, the shortened output lines experienced less loading capacitance than longer output lines and therefore allow the system to be operated at higher speeds.

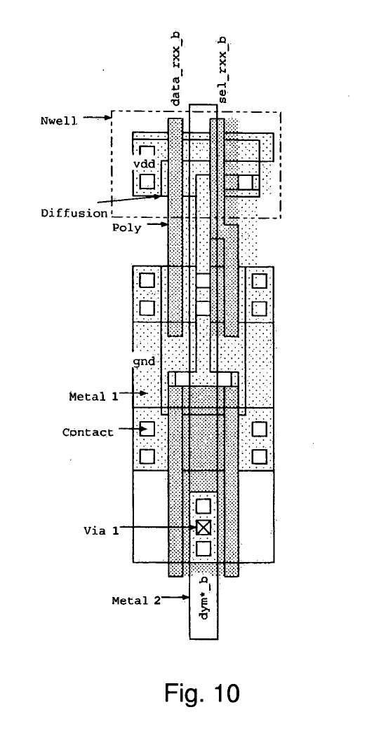

Another advantage that can be obtained in one embodiment is that the dynamic output lines can be located between shield wires. Referring to FIG. 10, a diagram illustrating the physical layout of the dynamic circuit of FIG. 6 in accordance with one embodiment is shown. FIG. 10 shows the “vertical” configuration of the physical circuit in this embodiment, with the NOR gate above the discharge circuit in the figure. In this configuration, the circuit components are positioned essentially as shown in FIG. 6. The circuit components are formed by multiple layers which are overlapping in the figure. It can be seen in this figure that the dynamic output signal line (carrying signal dym*_b) extends down the center of the circuit, and is shielded by ground wires. This shielding further minimizes the interference that can be caused by coupling capacitance.

The foregoing description focuses primarily upon embodiments that correspond to the specific configuration illustrated in FIG. 1. This configuration is designed to forward 32-bit data values from ten result registers to six instruction registers. It should be noted that alternative embodiments may be designed to operate in processors that have different configurations. For example these alternative embodiments may be designed to handle different bit-widths, different numbers of result registers, different numbers of instruction registers, different numbers of pipelines, different numbers of functional units, different numbers of pipeline stages, and so on.

Those of skill in the art will understand that information and signals may be represented using any of a variety of different technologies and techniques. For example, data, instructions, commands, information, signals, bits, symbols, and the like that may be referenced throughout the above description may be represented by voltages, currents, electromagnetic waves, magnetic fields or particles, optical fields or particles, or any combination thereof. The information and signals may be communicated between components of the disclosed systems using any suitable transport media, including wires, metallic traces, vias, optical fibers, and the like.

The various illustrative logical blocks, modules, and circuits described in connection with the embodiments disclosed herein may be implemented or performed with application specific integrated circuits (ASICs), field programmable gate arrays (FPGAs), general purpose processors, digital signal processors (DSPs) or other logic devices, discrete gates or transistor logic, discrete hardware components, or any combination thereof designed to perform the functions described herein. A general purpose processor may be any conventional processor, controller, microcontroller, state machine or the like. A processor may also be implemented as a combination of computing devices, e.g., a combination of a DSP and a microprocessor, a plurality of microprocessors, one or more microprocessors in conjunction with a DSP core, or any other such configuration.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein and recited within the following claims.

What is claimed is:

1. A forwarding mechanism for a pipelined processor comprising:
a first unit including
a data register; and
a set of dynamic data selection circuits;
wherein each of the dynamic data selection circuits is located adjacent to the data register;
wherein a position of the set of dynamic data selection circuits is a first direction from the data register; and
wherein the dynamic data selection circuits are positioned successively along a second direction which is perpendicular to the first direction.

2. The forwarding mechanism of claim 1, further comprising one or more additional units identical to the first unit, wherein the first unit and the additional units are positioned successively adjacent to each other along the first direction to form an alternating linear series of data registers and sets of data selection circuits.

3. The forwarding mechanism of claim 2, wherein the data register and dynamic data selection circuits are one bit wide, and wherein the first and additional circuits form a one-bit, n-way, m-port multiplexer, where n is a number of the first and additional units and m is a number of the dynamic data selection circuits in each set.

4. The forwarding mechanism of claim 3, further comprising one or more additional one-bit, n-way, m-port multiplexers to form a multiple bit wide, n-way, m-port multiplexer.

5. The forwarding mechanism of claim 1, wherein when each set of dynamic data selection circuits includes a number, m, dynamic data selection circuits, the first unit further comprises m common output lines, wherein each common output line is coupled to one of the dynamic data selection circuits in each set of dynamic data selection circuits.

6. The forwarding mechanism of claim 5, wherein each of the common output lines is positioned between shield wires in the ones of the dynamic data selection circuits to which the common output line is coupled.

7. The forwarding mechanism of claim 6, wherein the shield wires comprise ground wires.

8. The forwarding mechanism of claim 1, wherein each dynamic data selection circuit includes a plurality of components that are aligned in the first direction.

9. The forwarding mechanism of claim 8, wherein the plurality of components include a 2-input NOR gate and a discharge circuit, wherein the NOR gate is configured to receive a data bit and a select signal and to provide a NOR output to the discharge circuit, wherein the discharge circuit is coupled between a data output line and ground and is configured to discharge the data output line to ground when the output of the NOR gate is high and to isolate the data output line from ground when the output of the NOR gate is low.

10. The forwarding mechanism of claim 9, further comprising a precharge circuit coupled to the data output line, wherein the precharge circuit is configured to precharge the data output line.

11. The forwarding mechanism of claim 10, further comprising a pair of cross-coupled NAND gates coupled to the data output line and the precharge circuit, wherein the cross-coupled NAND gates are configured to transform a half-clock-cycle data signal to a full-clock-cycle data signal.

12. The forwarding mechanism of claim 1, wherein each of the dynamic data selection circuits is individually controllable to either select or deselect a data value stored in the data register.

13. The forwarding mechanism of claim 1, further comprising a set of destination registers, wherein data selected by the dynamic data selection circuits is forwarded to corresponding ones of the destination registers.

14. The forwarding mechanism of claim 1, further comprising a set of functional pipeline stages, wherein data selected by the dynamic data selection circuits is forwarded to corresponding ones of the functional pipeline stages.

15. A forwarding unit for use in a pipelined microprocessor comprising:
a plurality of source registers;
a multiplexer; and
one or more destination registers;
wherein the multiplexer includes a plurality of dynamic register selection circuits, wherein each of the dynamic register selection circuits is coupled between one of the plurality of source registers and one of the destination registers, wherein the dynamic register selection circuits are physically positioned in an alternating linear series with the plurality of source registers, and wherein all of the dynamic register selection circuits that are coupled to a single source register are physically positioned side-by-side along a direction perpendicular to the alternating linear series of source registers and dynamic register selection circuits.

16. The forwarding unit of claim 15, wherein each of the dynamic register selection circuits comprises a NOR gate and a discharge circuit, wherein the NOR gate has a first input coupled to receive a select signal, a second input coupled to receive a data signal, and an output coupled to a control input of the discharge circuit, and wherein the discharge circuit is configured to discharge a data line coupled to the corresponding destination register when the NOR gate output is asserted.

17. The forwarding unit of claim 16, wherein the NOR gate and discharge circuit of each dynamic register selection circuit are linearly positioned in a direction parallel to the linear series of source registers and dynamic register selection circuits.

18. The forwarding unit of claim 16, wherein the data line is physically positioned between shield wires of the dynamic register selection circuits.

19. The forwarding unit of claim 16, further comprising a precharge circuit coupled to the data line, wherein the precharge circuit is configured to periodically precharge the data output line.

20. The forwarding unit of claim 16, further comprising a pair of cross-coupled NAND gates coupled to the data line and the precharge circuit, wherein the cross-coupled NAND gates are configured to transform a half-clock-cycle data signal on the data line to a full-clock-cycle data signal.
